(19) United States
(12) Patent Application Publication
(10) Pub. No.: US 2026/0167068 A1
(43) Pub. Date: Jun. 18, 2026

(54) SEAT

(71) Applicants: Hyundai Motor Company, Seoul (KR); Kia Corporation, Seoul (KR); DAE WON SAN UP CO., LTD, Ansan-si (KR)

(72) Inventors: Mu Young KIM, Hwaseong-Si (KR); Jong Min PARK, Hwaseong-Si (KR); Dae Myoung PARK, Hwaseong-Si (KR); Sung Ho PARK, Hwaseong-Si (KR); Sang Woo KIM, Hwaseong-Si (KR); Yeon Soo EO, Hwaseong-Si (KR); Min Ha LEE, Hwaseong-Si (KR); Min Sik KIM, Hwaseong-Si (KR); Da Yeong KIM, Hwaseong-Si (KR); Young Joo CHO, Hwaseong-Si (KR); Soo Beom KWAK, Hwaseong-Si (KR); Hee Dong CHOI, Hwaseong-Si (KR); Seok Ju GIM, Hwaseong-Si (KR); Hyuk KIM, Ansan-si (KR); Jong Seong LEE, Ansan-si (KR); Jong Hyuk JEONG, Incheon (KR); Yong Cheol JANG, Ansan-si (KR)

(21) Appl. No.: 19/258,002

(22) Filed: Jul. 2, 2025

(30) Foreign Application Priority Data
Dec. 13, 2024 (KR) 10-2024-0186420

(51) Int. Cl. B60N 2/23; B60N 2/02

(52) U.S. Cl. CPC B60N 2/233; B60N 2/02253; B60N 2/02258

(57) ABSTRACT

A seat includes a base frame, side seat cushion frames spaced apart from each other on the base frame on left and right sides and connected to a front hinge pipe on a front side thereof and a rear hinge pipe on a rear side thereof, a seatback frame rotatably fastened to a rear end of the side seat cushion frame, an extension frame connected between the side seat cushion frame and the seatback frame, and a lift that is installed in a lengthwise direction of a set bracket supporting the side seat cushion frame, includes a link part moving forward or rearward due to a driving force of a driving motor, and elevates the rear hinge pipe about the front hinge pipe.

### CROSS-REFERENCE TO RELATED APPLICATION

This application claims the benefit of priority to Korean Patent Application No. 10-2024-0186420, filed in the Korean Intellectual Property Office on Dec. 13, 2024, the entire contents of which are incorporated herein by reference.

### TECHNICAL FIELD

The present disclosure relates to a fold-and-dive seat.

### BACKGROUND

A seat of a vehicle may be capable of a folding operation of folding a seatback over a seat cushion (e.g., to provide loading space behind the seatback) and a dive operation of lowering a front portion of the seat cushion to make a rear surface of the folded seatback a horizontal plane (e.g., when a long item, etc., is loaded in a space behind/over the seatback).

The seat may be equipped with a reclining mechanism for reclining the seatback to the rear side (e.g., to implement a comfortable posture in a vehicle for rest and/or sleep of an occupant), in addition to the fold-and-dive mechanism for folding the seatback.

In the case of the fold-and-dive seat, rear reclining of the seatback may be adjusted by the reclining mechanism in a basic posture, and in this case, the seat cushion is maintained in the basic posture.

On the other hand, in the case of the fold-and-dive seat, the dive operation of lowering the front portion of the seat cushion may be performed by the fold-and-dive mechanism to make the rear surface of the seatback a horizontal plane when the seatback is folded.

In this way, in the case of the fold-and-dive seat, it is not easy to configure other components at a lower end of a front side of the seat cushion due to a feature that the front side of the seat cushion is lowered when the seatback is folded, and it is difficult to implement a complete full-flat feature of the seatback because the amount of movement by which the seat cushion may be lowered is limited.

Further, to apply a relaxation mode that enables angle adjustment of the seat cushion may require complicated component structures and an increased number of components, which may be disadvantageous in terms of costs and weight.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a seat. A seat may comprise: a base frame; a first side seat cushion frame provided on a first side of the base frame; a second side seat cushion frame provided on a second side of the base frame opposite the first side; a front hinge pipe connecting a front side of the first side seat cushion frame to a front side of the second side seat cushion; a rear hinge pipe connecting a rear side of the first side seat cushion frame to a rear side of the second side seat cushion; a seatback frame rotatably fastened to rear ends of the first and second side seat cushion frames; a first extension frame connecting the first side seat cushion frame and the seatback frame; a second extension frame connecting the second side seat cushion frame and the seatback frame; and lifts installed in a lengthwise direction of set brackets supporting the first and second side seat cushion frames, wherein the lifts each comprise a rotation link configured to rotate via a driving force of a driving motor to elevate or lower the rear hinge pipe relative to the front hinge pipe.

A seat may comprise: a base frame; a side seat cushion frame provided a side of the base frame; a front hinge pipe connected to a front side of the side seat cushion frame; a rear hinge pipe connected to a rear side of the side seat cushion frame; a seatback frame rotatably fastened to a rear end of the side seat cushion frame; a driving motor configured to drive a lead screw to move in a forward direction or a rearward direction; and a rotation link comprising a first end connected to the lead screw so as to move with the lead screw in the forward direction or the rearward direction, wherein: the rotation link is rotatably connected to a support at a point such that a second end of the rotation link, opposite to the first end of the rotation link, is configured to lower or rise via rotation about the point based on movement of the first end in the forward direction or the rearward direction; and the second end of the rotation link is connected to the rear hinge pipe.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a seat frame of a seat according to an example of the present disclosure;

FIG. 2 is a view illustrating an operation state of a full flat mode in the seat frame of the seat according to the example of the present disclosure;

FIG. 3 is a view illustrating a state before and after an operation of the full flat mode of the seat according to the example of the present disclosure;

FIG. 4 is a perspective view illustrating the seat in the full flat mode according to the example of the present disclosure;

FIG. 5 is a view illustrating an operation state of a relaxation mode in the seat frame of the seat according to the example of the present disclosure;

FIG. 6 is a view illustrating a state before and after an operation of the relaxation mode of the seat according to the example of the present disclosure; and

FIG. 7 is a perspective view illustrating the seat in the relaxation mode according to the example of the present disclosure.

### DETAILED DESCRIPTION

Hereinafter, some examples of the present disclosure will be described in detail with reference to the drawings. When the reference numerals are added to the components of the drawings, the same components have the same reference numerals as much as possible even when the components are illustrated in different drawings. Further, in describing the examples of the present disclosure, a detailed description of the related known configurations or functions will be omitted when it is determined that such description would interfere with the understanding of the present disclosure.

Further, in the description of components of the examples of the present disclosure, the terms such as first, second, A, B, (a) and (b) may be used. These terms are merely intended to distinguish one component from other components, and the terms do not limit the nature, order, or sequence of the components. It should be understood that when one component is “connected”, “coupled” or “joined” to another component, the former may be directly connected or jointed to the latter or may be “connected”, “coupled” or “joined” to the latter with a third component interposed therebetween.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

The expression “based on” as used herein is intended to describe one or more factors that influence an act or operation of determining or deciding described in a phrase or sentence including that expression, and this expression does not exclude any additional factors that influence the act or operation of determining or deciding.

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

Directional terms “front”, “rear”, “side”, “left”, “right”, “under”, etc., refer to directions as they would be perceived relative to a user sitting in the seat disclosed herein. Use of directional terms are for ease of understanding and do not limit the seat disclosed herein to any particular orientation or configuration. Use of directional terms does not limit the seat to being installed in a vehicle or to being used by a user.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Hereinafter, a seat according to an example of the present disclosure will be described in detail with reference to the accompanying drawings.

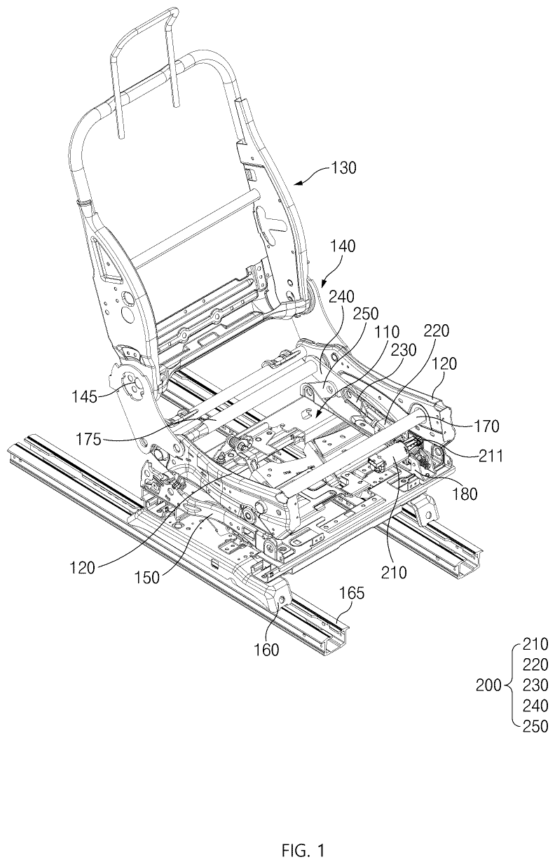

FIG. 1 is a view illustrating a seat frame 100 of a seat according to an example of the present disclosure.

Referring to FIG. 1, the seat frame 100 of the seat according to the present disclosure may include a base frame 110, a pair of side seat cushion frames 120 spaced apart from each other and positioned on left and right sides of the base frame 110, respectively, and a seatback frame 130 rotatably fastened to rear ends of the side seat cushion frames 120.

The base frame 110 may be configured to support a user sitting on the seat (e.g., hips and thighs of a user when the user sits on the seat), and various cushion structures (e.g., in which a sponge, urethane, or a spring is installed inside a soft cloth or synthetic/natural leather in a hard material such as plastic or metal or a frame) may be applied to the base frame 110. The base frame 110 may be a frame structure having a circular shape and/or a quadrangular shape as a whole to sufficiently support the hips and the thighs of the user.

The side seat cushion frames 120 may be spaced a predetermined distance from each other (e.g., on the left and right sides of the base frame 110, respectively). Front and rear hinge pipes 170 and 175 may each be coupled between the side seat cushion frames 120 (e.g., connecting the side seat cushion frames 120).

The front hinge pipe 170 may be installed in front of the side seat cushion frame 120 and may be/function as a rotation center when/if the side seat cushion frame 120 is elevated by a rotation link 240 and the rear hinge pipe 175.

The rear hinge pipe 175 may be simultaneously hinge-connected to the rotation link 240 and the side seat cushion frame 120 to assist an elevation operation of the side seat cushion frame 120 when/if the rotation link 240 is rotated.

The seatback frame 130 may be a frame structure that is formed in a shape corresponding to a back of the user to support the back of the user. The seatback frame 130 may be hinge-coupled to a recliner 145 (e.g., a recliner joint/hinge). The seatback frame 130 may have a circular shape or a quadrangular shape as a whole.

Various cushion structures (e.g., in which a sponge, urethane, or a spring, etc., is installed inside a soft cloth or synthetic/natural leather in a hard material such as plastic or metal or a frame) may be applied to the seatback frame 130. The seatback frame 130 may be interlocked to be tilted in a front-rear direction by the recliner 145, for example, in a full flat mode or a relaxation mode.

An extension frame 140 may be installed at a connection point between the rear end of the side seat cushion frame 120 and a lower end of the seatback frame 130. The recliner 145 may be installed at a connection point between the seatback frame 130 and the extension frame 140.

A front tilting angle and/or a rear tilting angle of the seatback frame 130 may be adjusted by/via the recliner 145. For example, the seatback frame 130 may be reclinably installed at the rear end of the side seat cushion frame 120 through/via the recliner 145. The seatback frame 130 may be reclined frontward and rearward (e.g., manually and/or automatically by the user when/if the recliner 145 is unlocked). The seatback frame 130 may be coupled to the extension frame 140 to adjust an angle in the front-rear direction by the recliner 145.

Since the side seat cushion frame 120 and the seatback frame 130 are connected to each other by means of the extension frame 140, the side seat cushion frame 120 and the seatback frame 130 may move together (e.g., in a front/rear direction, etc.) while interlocking with each other through/via the extension frame 140.

A set bracket 150 that supports the side seat cushion frame 120 may be installed under each of the side seat cushion frame 120. The set brackets 150 may be arranged to be spaced apart from each other on the left and right sides of the base frame 110 (e.g., to correspond to the side seat cushion frames 120). A moving rail 160 may be installed under the set bracket 150.

The moving rail 160 may be coupled to a fixed rail 165 (e.g., fixed to a floor panel of a vehicle) when/if the seat is installed in a vehicle, for instance. The moving rail 160 coupled to the fixed rail 165 may allow the seat to be movable in the front-rear direction, and thus adjust a position of the seat in the front-rear direction.

For example, the side seat cushion frame 120 may be elevatably connected to a rear end of the base frame 110 by the rotation link 240, and the extension frame 140 for a reclining operation may be connected between the side seat cushion frame 120 and the seatback frame 130.

A first end of the extension frame 140 may be hinge-coupled to an outer surface of the side seat cushion frame 120 through/via the hinge (not illustrated) while forming a predetermined angle for connection with the side seat cushion frame 120. A second end, opposite to the first end, of the extension frame 140 may be coupled to an outer surface of the seatback frame 130 via the recliner 145 while forming a predetermined angle.

The seatback frame 130 may be rotatably coupled to the extension frame 140, the extension frame 140 may be coupled to the side seat cushion frame 120, and thus the seatback frame 130 may be able to recline via the reclining operation in the front-rear direction.

The example of the present disclosure allows for easily implementing the full flat mode and/or the relaxation mode by tiltably driving the rear end of the side seat cushion frame 120 such that the rear hinge pipe 175 moves upward or downward with respect to the front hinge pipe 170.

To this end, in the example of the present disclosure, a lift (e.g., a lift 200) for operating the rear hinge pipe 175 is provided.

The lift 200 may include a driving motor 210, a lead screw 220, a connection link 230, the rotation link 240, and a support link 250. The lift 200 may be provided in a lengthwise direction of the set bracket 150 (e.g., extending and/or arranged substantially in the lengthwise direction of the set bracket 150, from front to rear).

The side seat cushion frame 120 may be provided with the driving motor 210. The driving motor 210 may include a gearbox 211, which may comprise a reduction part (e.g., a reducer) mounted on a motor shaft (not illustrated). The driving motor 210 may be fastened to an output gear (not illustrated) in the gearbox 211 so that the lead screw 220 may move forward or backward by driving of the driving motor 210.

The lead screw 220 may be installed on a fixing bracket 180 mounted on the base frame 110. For example, the fixing bracket 180 may be fixed to a front side of the set bracket 150. The fixing bracket 180 may include/form an accommodation space in which the lead screw 220 may be stably accommodated. A front end portion of the lead screw 220 may be connected to the fixing bracket 180 by a hinge.

The driving motor 210 may be defined as a motor capable of implementing a fold-and-dive function for the full flat mode of the seat, as disclosed herein.

A reclining motor provided in/associated with the recliner 145 of the seat and capable of implementing a reclining function via the recliner 145 may be separately configured.

The two motors may be simultaneously driven (e.g., by a knob switch, not illustrated). Also, or alternatively, the recliner motor may independently cause the recliner 145 to implement the reclining operation, and/or the user may manually implement the reclining operation.

The driving motor 210 applied to the example of the present disclosure may be a motor capable of implementing the fold-and-dive function.

A first end of the lead screw 220 may be connected to the fixing bracket 180, and a second end of the lead screw 220, opposite to the first end of the lead screw 220, may be connected to the connection link 230.

A first end of the connection link 230 may be connected to the lead screw 220, and a second end of the connection link 230, opposite to the first end of the connection link 230, may be connected to the rotation link 240.

The lead screw 220 may not be directly connected to the rotation link 240 (e.g. without the connection link 230 therebetween). However, the lead screw 220 connected to the connection link 230 may allow for an operation to be more effectively implemented.

A first end of the rotation link 240 may be connected to the connection link 230, and a second end of the rotation link 240, opposite to the first end of the rotation link 240, may be connected to the rear hinge pipe 175. As the rear hinge pipe 175 is hinge-connected between the pair of side seat cushion frames 120 spaced apart from each other, the side seat cushion frame 120 may be interlocked by a tilting operation of the rotation link 240.

A first end of the support link 250 may be connected to a point of the rotation link 240 between the first and second ends of the rotation link 240 (e.g., connected to a middle of the rotation link 240). A second end of the support link 250, opposite the first end of the support link 250, may be rotatably connected to an inner side surface of the set bracket 150. The support link 250 may have the same traveling direction together with the rotation link 240.

The seat according to the example of the present disclosure may implement the full flat mode when/if front folding of the seatback is adjusted, and may implement the relaxation mode when rear reclining of the seatback is adjusted.

The full flat mode and/or the relaxation mode of the seat may be executed by the lift 200 including the driving motor 210, the lead screw 220, the connection link 230, the rotation link 240, and the support link 250 and connected to a link part.

The lead screw 220 may be fastened to the output gear (not illustrated) in the gearbox 211 of the driving motor 210. As such, the lead screw 220 may be moved forward or rearward by movement of the output gear driven by the driving motor. The connection link 230 may be fastened to a rear side of the lead screw 220 (e.g., a second end of the lead screw 220 opposite a first end of the lead screw 220 fastened to the output gear) to move forward or rearward.

The rotation link 240 connected to the rear side (e.g., second end) of the connection link 230 may be hinge-coupled to the set bracket 150 by/via the connection link 230, and at the same time, may be hinge-coupled to the side seat cushion frame 120 by the rear hinge pipe 175.

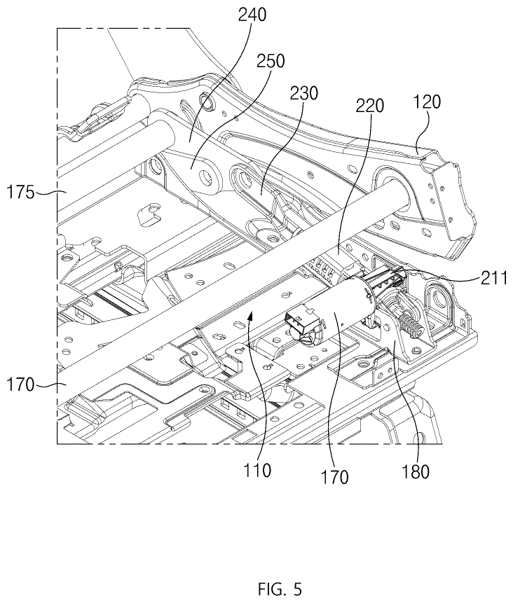

Thus, when/if the lead screw 220 moves forward (e.g., due to the driving of the driving motor 210), the first end (e.g., a front end) of the rotation link 240 may be pulled forward, the second end (e.g., a rear end) of the rotation link 240 may be lowered, and at the same time, the rotation link 240 may be maintained/positioned in an approximately horizontal state with/via the support link 250 (see, e.g., FIG. 5).

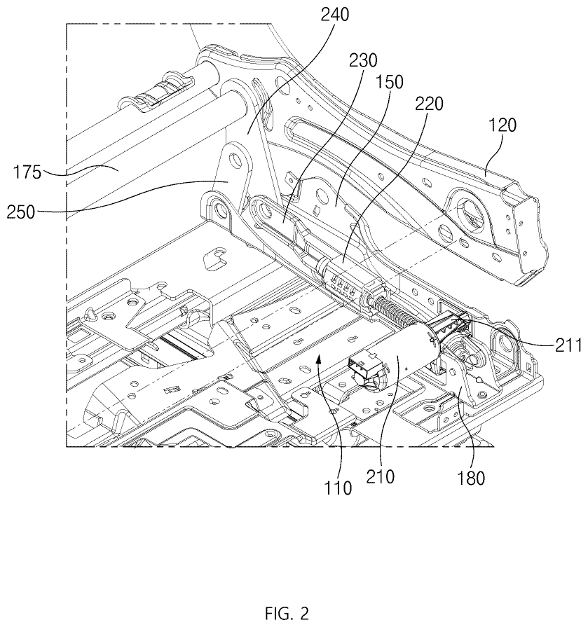

When/if the lead screw 220 moves rearward (e.g., due to the driving of the driving motor 210), the first end (e.g., a front end) of the rotation link 240 may be pushed rearward, the second end (e.g., the rear end) of the rotation link 240 may be raised, and at the same time, the rotation link 240 may be maintained/positioned in an approximately vertical state with/via the support link 250 (see, e.g., FIG. 2).

Operation flows for the full flat mode and the relaxation mode of the seat disclosed herein will be described as follows.

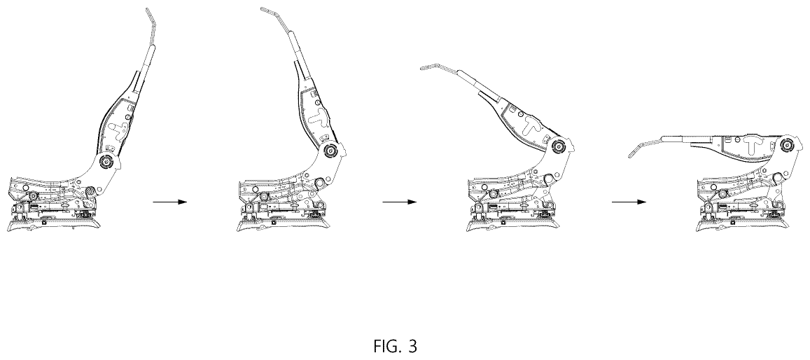

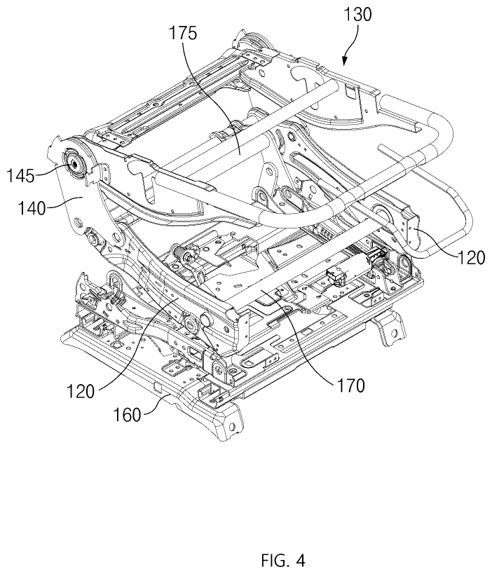

FIG. 2 is a view illustrating an operation state of a full flat mode in the seat frame of the seat according to the example of the present disclosure, FIG. 3 is a view illustrating a state before and after an operation of the full flat mode of the seat according to the example of the present disclosure, and FIG. 4 is a perspective view illustrating the seat in the full flat mode according to the example of the present disclosure.

Referring to the accompanying drawings, the side seat cushion frame(s) 120 may be maintained in a horizontal state before the full flat mode (e.g., in an upright mode) of the seat frame 100, and the rotation link 240 that controls a posture of the side seat cushion frame 120 may also be maintained in an approximately horizontal state.

The rotation link 240 may be disposed to be inclined upward (e.g., at a predetermined angle toward the rear side). The first end of the support link 250, connected to the middle of the rotation link 240 between the first and the second ends of the rotation link 240, may be disposed to be inclined upward at a predetermined angle toward the front side. That is, second ends of the rotation link 240 and the support link 250 may be spaced apart from each other at a predetermined angle toward the rear side (e.g., a vertex of the angle being a connection point between the first end of the support link 250 and the middle/point of the rotation link 240).

Referring to the first drawing of FIG. 3, the seatback frame 130 and the extension frame 140 may be arranged in a substantially straight line at a predetermined angle toward the rear side before a front folding operation of the seatback frame 130 and the extension frame 140 (e.g., in an upright position and/or a rear reclining position).

When/if the user selects (e.g., operates a knob switch and/or provides input to an interface of the vehicle, etc.) to implement the fold-and-dive function (e.g., including front folding of the seatback and a dive operation of the seat cushion), a controller (e.g., control device, control computing device, control panel, not illustrated) may be configured to receive a signal indicating the selection (e.g., receive input via the interface, receive a switching signal of the knob switch, etc.). The controller may perform, based on the received signal, a control operation to apply a current to the driving motor 210. For example, the controller may apply a control signal to cause application of the current and/or apply the current based on the received selection signal. The control operation may cause the driving motor 210 to be driven. A separate motor for a front folding operation of the seatback may also, or alternatively, be operated together with the driving motor 210, and/or the user may (e.g., manually) implement the front folding operation.

The controller may include a communication device communicating with other controllers and/or a sensor/user interface to control one or more functions and/or operations in charge, a memory storing an operation system, a logic command, and/or input/output information, and/or one or more processors performing determination, calculation, and/or decision necessary for controlling the function in charge. The controller may include, for example, a processor, a central processing unit (CPU), a microchip, a logic, an application-specific integrated circuit (ASIC), memory, etc. The controller may manipulate and/or control other components in the system (e.g., the driving motor 210), for example, by applying a current and/or causing application of a current to the driving motor 210 to cause driving of the driving motor 210.

When/if the lead screw 220 moves rearward (e.g., according to/based on the driving of the driving motor 210), it may push the connection link 230 and correspondingly the rotation link 240 rearward (e.g., a first end of the rotation link 240 rearward). As the rotation link 240 and the support link 250 move rearward, the second end (e.g., the rear end) of the rotation link 240 may be raised while rotating about a hinge fastening point with the support link 250.

When/if the second end (e.g., rear end) of the rotation link 240 is raised (e.g., by rotating), the rear end of the side seat cushion frame 120 to which the rear hinge pipe 175 is connected, along with the rear hinge pipe 175 to which the rotation link 240 is connected, may be raised. This operation may cause the seatback frame 130 to be full flat.

The seatback frame 130 may have a small rotation angle with respect to the extension frame 140, such that the amount of rotation (e.g., forward folding rotation) of the seatback frame 130 is limited. As the second end (e.g., rear end) of the side seat cushion frame 120 is raised, a rear surface of the seatback may be oriented further in a horizontal state, such that the seatback frame 130 may be implemented in the full flat mode without, for example, lowering bolsters formed to be convex on opposite sides of the seatback.

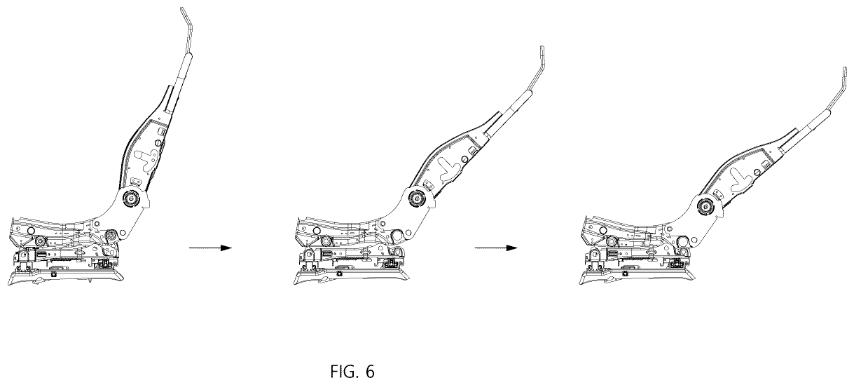

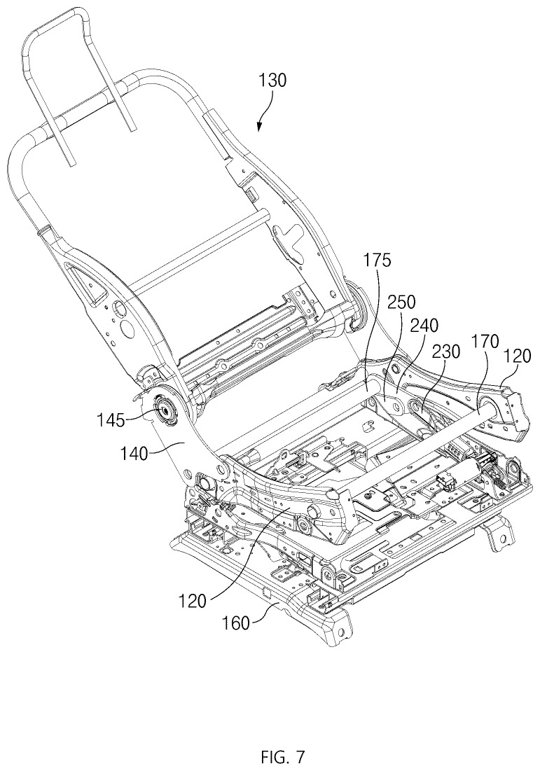

FIG. 5 is a view illustrating an operation state of a relaxation mode in the seat frame of the seat according to the example of the present disclosure, FIG. 6 is a view illustrating a state before and after an operation of the relaxation mode of the seat according to the example of the present disclosure, and FIG. 7 is a perspective view illustrating the seat in the relaxation mode according to the example of the present disclosure.

Referring to the accompanying drawings, the side seat cushion frame(s) 120 may be maintained in a horizontal state before the relaxation mode of the seat frame 100 (e.g., in an upright mode). The rotation link 240 that controls the posture of the side seat cushion frame(s) 120 may be in an approximately horizontal state.

The rotation link 240 may be disposed to be inclined upward at a predetermined angle toward the rear side of the seat. The first end of the support link 250 connected to the middle of the rotation link 240 (e.g., between the first and second ends of the rotation link 240) may be disposed to be inclined upward at a predetermined angle toward the front side. That is, the second ends of the rotation link 240 and the support link 250 may be spaced apart from each other at a predetermined angle toward the rear side.

Referring to the first drawing of FIG. 6, the seatback frame 130 and the extension frame 140 may be arranged in a substantially straight line at a predetermined angle toward the rear side before a rear reclining operation of the seatback frame 130 and the extension frame 140.

When/if the user selects (e.g., operates the knob switch and/or provides input to interface to an interface of the vehicle, etc.) to implement the relaxation operation of the seat frame 100, the controller (not illustrated), may receive a signal (e.g., receive input via the interface, receive a switching signal of the knob switch, etc.). The controller may perform a control to apply a current to the driving motor 210 to drive the driving motor 210 may be driven. For example, the controller may send a control signal to cause application of the current and/or apply the current to the driving motor 210. A separate/second motor for a rear reclining operation of the seatback may also be operated together with the control of the driving motor 210, and/or the user may (e.g., manually) implement the rear reclining operation.

When/if the connection link 230 and the rotation link 240 are pulled forward (e.g., by the lead screw 220 moving forward according to the driving of the driving motor 210), the rotation link 240 and the support link 250 may move forward, accordingly. An angle between the rotation link 240 and the support link 250 may decrease. Accordingly, the rear end of the rotation link 240 may be lowered while rotating about the hinge fastening point with the support link 250.

When/if the second end (e.g., rear end) of the rotation link 240 is lowered (e.g., while/by rotating about the hinge fastening point), the rear side of the side seat cushion frame 120, connected to the rear hinge pipe 175 together with the rear hinge pipe 175 to which the rotation link 240 is connected, may be lowered. Thus the rear end of the side seat cushion frame 120 may be tilted downward (e.g., relative to a front end of the seat cushion frame 120.

When/if the rear reclining of the seatback frame 130 is adjusted, as the rear end of the side seat cushion frame 120 may be tilted downward, a body pressure may be easily distributed on the hips and the thighs of the user, and accordingly, by preventing fatigue of a lower body from increasing, the relaxation mode in which the user is comfortable may be implemented.

The present disclosure has been made to solve the above-mentioned problems occurring in the prior art while advantages achieved by the prior art are maintained intact.

An example of the present disclosure provides a seat capable of implementing a full flat mode when front folding of a seatback is adjusted and implementing a relaxation mode when rear reclining is adjusted.

The technical problems to be solved by the present disclosure are not limited to the aforementioned problems, and any other technical problems not mentioned herein will be clearly understood from the following description by those skilled in the art to which the present disclosure pertains.

The present disclosure provides a seat capable of implementing a full flat mode when folding of a seatback is adjusted and implementing a relaxation mode when reclining is adjusted.

According to an example of the present disclosure, a seat includes a base frame, side seat cushion frames spaced apart from each other on the base frame on left and right sides and connected to a front hinge pipe on a front side thereof and a rear hinge pipe on a rear side thereof, a seatback frame rotatably fastened to a rear end of the side seat cushion frame, an extension frame connected between the side seat cushion frame and the seatback frame, and an lift that is installed in a lengthwise direction of a set bracket supporting the side seat cushion frame, includes a link part moving forward or rearward due to a driving force of a driving motor, and elevates the rear hinge pipe about the front hinge pipe.

According to an example of the present disclosure, the lift may include a lead screw fastened to move forward or rearward by driving of the driving motor, a connection link connected to the lead screw, and a rotation link hinge-coupled to the connection link and the rear hinge pipe and raised or lowered while a rear end thereof rotates by the forward or rearward movement of the lead screw.

According to an example of the present disclosure, the seat may further include a support link having one end connected to a middle end of the rotation link to have the same traveling direction as the rotation link and an opposite end rotatably connected to an inner side surface of the set bracket.

According to an example of the present disclosure, the rotation link may have one end hinge-coupled to the connection link, an opposite end hinge-coupled to the rear hinge pipe, and the middle end hinge-coupled to the support link rotatably supported by the set bracket.

According to an example of the present disclosure, the rotation link may be hinge-coupled to the set bracket by the support link, and at the same time, may be hinge-coupled to the side seat cushion frame by the rear hinge pipe.

According to an example of the present disclosure, the rotation link may be disposed to be inclined upward at a predetermined angle toward a rear side before a full flat mode and a relaxation mode, the support link may be disposed to be inclined upward at a predetermined angle toward a front side, and the rotation link and the support link may be maintained in a state of being spaced apart from each other by a predetermined angle toward the rear side.

According to an example of the present disclosure, the rotation link may raise the rear end of the side seat cushion frame together with the rear hinge pipe while the rear end thereof rotates about a hinge fastening point with the support link in the full flat mode.

According to an example of the present disclosure, the rotation link may lower the rear end of the side seat cushion frame together with the rear hinge pipe while the rear end thereof rotates about a hinge fastening point with the support link in the relaxation mode.

According to an example of the present disclosure, the lead screw may be hinge-connected to a fixing bracket mounted on the base frame and having an accommodation space for the lead screw.

According to the seat according to the present disclosure, a full flat mode may be implemented when front folding of a seatback is adjusted, and a relaxation mode may be implemented when rear reclining is adjusted.

A seat cushion may be independently tilted regardless of a position of a seatback, and thus a relaxation posture desired by a user may be implemented.

When a full flat mode of a seatback is implemented, the seatback may be used as a table.

The above description of the present disclosure is for illustration, and those skilled in the art to which the present disclosure pertains may understand that the present disclosure may be easily modified into other specific forms without changing the technical spirit or essential feature of the present disclosure. Therefore, it should be understood that the examples described above are illustrative but not limiting in all aspects. The scope of the present disclosure is indicated by the appended claims, and all changes or modifications derived from the meaning and scope of the appended claims and equivalent concepts thereof should be construed as being included in the scope of the present disclosure.

What is claimed is:

1. A seat comprising:
a base frame;
a first side seat cushion frame provided on a first side of the base frame;
a second side seat cushion frame provided on a second side of the base frame opposite the first side;
a front hinge pipe connecting a front side of the first side seat cushion frame to a front side of the second side seat cushion;
a rear hinge pipe connecting a rear side of the first side seat cushion frame to a rear side of the second side seat cushion;
a seatback frame rotatably fastened to rear ends of the first and second side seat cushion frames;
a first extension frame connecting the first side seat cushion frame and the seatback frame;
a second extension frame connecting the second side seat cushion frame and the seatback frame; and
lifts installed in a lengthwise direction of set brackets supporting the first and second side seat cushion frames, wherein the lifts each comprise a rotation link configured to rotate via a driving force of a driving motor to elevate or lower the rear hinge pipe relative to the front hinge pipe.

2. The seat of claim 1, wherein each lift of the lifts comprises:
a lead screw configured to move forward or rearward via the driving force of the driving motor; and
a connection link comprising a first end connected to the lead screw, wherein:
a first end of the rotation link is hinge-coupled to a second end of the connection link, opposite to the first end of the connection link; and
a second end of the rotation link is connected to the rear hinge pipe and elevated or lowered based on movement of the lead screw via the driving force of the motor.

3. The seat of claim 2, further comprising:
a support link comprising:
a first end connected to a point of the rotation link between the first and second ends of the rotation link; and
a second end, opposite to the first end, rotatably connected to an inner side surface of a first set bracket of the set brackets.

4. The seat of claim 3, wherein:
the second end of the rotation link is hinge-coupled to the rear hinge pipe, and
the support link is hinge-coupled to the rotation link at the point via a hinge at the point.

5. The seat of claim 3, wherein the rotation link is hinge-coupled, via the support link, to the first set bracket by the support link, and is hinge-coupled, via the rear hinge pipe, to the first side seat cushion frame.

6. The seat of claim 4, wherein the seat is adjustable between a plurality of configuration modes comprising an upright mode in which:
the rotation link is disposed to be inclined upward toward a rear side of the seat and the support link is disposed to be inclined upward at a first predetermined angle toward a front side of the seat, such that the rotation link and the support link form a first predetermined angle, at the hinge, toward the rear side of the seat.

7. The seat of claim 6, wherein the plurality of configuration modes further comprise a full flat mode in which:
the rotation link and the support link form a second predetermined angle, at the hinge, toward the rear side of the seat,
wherein the second predetermined angle is greater than the first predetermined angle such that the second end of the rotation link raises the rear ends of the first and second side seat cushion frames by raising the rear hinge pipe.

8. The seat of claim 6, wherein the plurality of configuration modes further comprise a relaxation mode in which:
the rotation link and the support link form a third predetermined angle, at the hinge, toward the rear side of the seat,
wherein the third predetermined angle is smaller than the first predetermined angle such that the second end of the rotation link lowers the rear ends of the first and second side seat cushion frames by lowering the rear hinge pipe.

9. The seat of claim 2, wherein the lead screw is hinge-connected to a fixing bracket mounted on the base frame and forming an accommodation space for the lead screw.

10. A seat comprising:
a base frame;
a side seat cushion frame provided a side of the base frame;
a front hinge pipe connected to a front side of the side seat cushion frame;
a rear hinge pipe connected to a rear side of the side seat cushion frame;
a seatback frame rotatably fastened to a rear end of the side seat cushion frame;
a driving motor configured to drive a lead screw to move in a forward direction or a rearward direction; and
a rotation link comprising a first end connected to the lead screw so as to move with the lead screw in the forward direction or the rearward direction, wherein:
the rotation link is rotatably connected to a support at a point such that a second end of the rotation link, opposite to the first end of the rotation link, is configured to lower or rise via rotation about the point based on movement of the first end in the forward direction or the rearward direction; and
the second end of the rotation link is connected to the rear hinge pipe.

11. The seat of claim 10, further comprising an extension frame connecting the side seat cushion frame to the seatback frame.

12. The seat of claim 10, further comprising a connection link comprising:
a first end connected to the lead screw; and
a second end hinge-coupled to the first end of the rotation link.

13. The seat of claim 10, wherein the support comprises a support link, the support link comprising:
a first end rotatably connected to the rotation link at the point; and
a second end, opposite to the first end of the support link, connected to the base frame.

14. The seat of claim 13, wherein an angle formed between the support link and the rotation link is configured to increase with rearward motion of the lead screw or decrease with forward motion of the lead screw.

15. The seat of claim 14, further comprising a control device configured to receive a control input and apply a current, based on the control input, configured to cause the driving motor to move the lead screw.

16. The seat of claim 15, wherein the control input indicates a selection of one of an upright mode, a full flat mode or a relaxation mode.

17. The seat of claim 16, wherein the control device is configured to, based on the control input indicating the upright mode, apply a current to cause the driving motor to move the lead screw to a position at which the angle is a first predetermined angle.

18. The seat of claim 17, wherein the control device is configured to, based on the control input indicating the full flat mode, apply a current to cause the driving motor to move the lead screw to a position at which the angle is a second predetermined angle greater than the first predetermined angle.

19. The seat of claim 17, wherein the control device is configured to, based on the control input indicating the relaxation mode, apply a current to cause the driving motor to move the lead screw to a position at which the angle is a third predetermined angle less than the first predetermined angle.
